(19) United States
(12) Patent Application Publication
(10) Pub. No.: US 2009/0047411 A1
(43) Pub. Date: Feb. 19, 2009

(54) Method and system for producing peanut hull flour

(76) Inventor: Benjamin E. Houston, Panacea, FL (US)

Correspondence Address: MAIER & MAIER, PLLC, 1000 DUKE STREET, ALEXANDRIA, VA, 22314, US

(21) Appl. No.: 11/889,829

(22) Filed: Aug. 16, 2007

(51) Int. Cl. A23L 1/211; A23L 1/20; B02B 5/02

(52) U.S. Cl. 426/632; 426/430; 99/483; 99/484; 99/534

(57) ABSTRACT

In accordance with at least one exemplary embodiment, a method and system of producing peanut hull flour is disclosed. The peanut hull flour can be fit for human consumption as, for example, a food-grade fiber additive. In an exemplary embodiment, a peanut hull mass (or supply) can be treated with an oxidizing solution such as a 3-70% hydrogen peroxide solution for one or more minutes to twelve hours. The peanut hull mass (or supply) can also be washed with an alkaline solution. Moreover, the peanut hull mass (or supply) can be dried to a resulting moisture content of 1-10%. Further, the peanut hull mass (or supply) can then be reduced to peanut hull flour, for example, by using a flour grinder system.

### BACKGROUND

Peanuts (Arachis hypogaea), also known as groundnuts, are an annual leguminous, herbaceous plant. The seeds (kernels) of such plants are also known as peanuts (and groundnuts). A peanut pod (fruit) has one or more peanut kernels encapsulated by a peanut hull (shell). Peanut hulls include: cellulose, which is the spongy part of the peanut shell; a matrix of fiber; and a glossy white or a glossy black liner that comprises the inner skin of the peanut shell. As such, peanut hulls are a source of cellulose and crude fiber.

According to the American Peanut Council (APC), peanut plants are harvested and then processed in various manners for human consumption. In regard to shelled (i.e. having the shells removed) peanuts, after harvesting and inspection, peanuts are typically subjected to a shelling process where the peanuts are first cleaned. The cleaned peanuts are then move by conveyor to shelling machines where peanuts are de-hulled as they are forced through perforated grates. Next, the peanuts pass through updraft air columns that separate the kernels from the hulls. Specific gravity machines then separate the kernels and the unshelled pods. Next, the kernels are then passed over the various perforated grading screens where they are sorted by size into market grades. The kernels are individually inspected with high-speed electronic color sorting equipment that eliminates discolored or defective kernels as well as any remaining foreign material.

Peanut butter, roasted and flavored kernels, roasted and sized peanut granules, salted in-shell peanuts, peanut flour, and peanut oil (both refined and crude) are all value-added products available from U.S. sellers, blanchers and/or manufacturers. These value-added peanut products have various applications within the bakery, confectionary and general consumer markets.

For example, peanut flour is used in confectionary products, seasoning blends, bakery mixes, frostings, filings, cereal bar and nutritional bars. Peanut flour is typically made from raw peanuts that have been cleaned, blanched and electronically sorted to select for high quality peanuts. The kernels (also commonly referred to as nuts in a culinary sense) are typically roasted and processed to obtain lower fat peanut flour with a roasted peanut flavor. Because the flour is partially defatted, it can be used as a fat binder in applications such as confection centers. In addition, using peanut flour at a level of 4-8% in a formulation has been found to extend the shelf life of confections and can contribute a peanut flavor to the product. Moreover, peanut flour is also good protein source because of its high protein content.

Peanut oil is another value-added peanut product. Peanut oil is extracted from shelled and crushed peanuts by one or more of hydraulic pressing, expeller pressing and solvent extraction. Highly aromatic 100% peanut oil and peanut extract are also available. These products have a strong roasted peanut flavor and aroma. Application for these products can include flavoring compounds, confections, sauces and baked goods.

As another example of a value-added product, roasted peanuts are available in several different packages and roast variations. Different coatings can be applied to the peanuts prior to and after roasting to provide honey, smoked, sweet, spicy and salty flavoring. As yet another example, various peanut butters are commercially available. In producing peanut butter, peanuts are typically roasted, blanched and sorted before grinding into a creamy consistency. As a final example, peanut paste, which is 100% ground peanuts, is used in a variety of industrial food recipes and is available from processors according to the APC.

Although peanuts, particularly, peanut kernels are processed in various manners and used for various applications as described above, the peanut hulls are not commercially processed for human consumption in any form. Peanut hulls are largely considered to be a byproduct of the peanut industry. Products from peanut hulls are used in or as animal feeds, pesticide carriers (e.g., against fire ants), fertilizer carriers, fuel for commercial boilers, animal litter (e.g., poultry house litter), plastic composite materials (e.g., as a polyethylene filler) and industrial absorbents, among others.

### SUMMARY

According to at least one embodiment, a method of producing peanut hull flour can include providing a peanut hull mass (or supply) and treating the peanut hull mass (or supply) with an oxidizing solution. The peanut hull mass (or supply) can also be washed with an alkaline solution. Moreover, the peanut hull mass (or supply) can be dried. Further, the peanut hull mass (or supply) can then be reduced to peanut hull flour. The peanut hull flour itself is in accordance with at least one embodiment of the present invention.

In another exemplary embodiment, a system for producing peanut hull flour can include a wet processing portion having one or more agitated vats for exposing a peanut hull mass (or supply) to at least an oxidizing solution and an alkaline solution. The system can also include a dry processing portion having a flour grinder system for reducing the peanut hull mass (or supply) into peanut hull flour.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is a flowchart showing an exemplary process for pre-processing a peanut hull supply into a peanut hull mass.

FIG. 2 is a flowchart showing an exemplary process for producing peanut hull flour from a peanut hull mass or a peanut hull supply.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

A method and system for producing peanut hull flour according to at least one exemplary embodiment of the present invention can produce food-grade peanut hull flour for use in various food products fit for human consumption. Particularly, the peanut hull flour is contemplated for use in food products that can benefit from additional dietary fiber.

For example, peanut hull flour in accordance with at least one exemplary embodiment can be used in various confections, peanut butters, peanut flour, sauces, baked goods and the like. For instance, the confectionary industry may benefit from food-grade peanut hull flour (e.g., as a fiber-additive) for incorporation into various food products, particularly, because it is believed that developing new ingredients in the confectionary industry is not customary. Also, food-grade peanut hull flour may be used in pharmaceuticals such as pills and in cosmetics for application on the human body as a couple other non-limiting examples.

It can be noted here that peanut hulls are primarily viewed by those in the peanut industry as being a byproduct of peanut processing. As such, lower priority is assigned to this component of peanut pods as compared to the peanut kernels for developing commercial uses thereof (e.g., as human consumable food products and additives).

Peanut hull flour produced according to at least one exemplary embodiment may provide another ingredient for food development scientists to incorporate into products they formulate (or reformulate). This application of peanut hull flour may be similar to how food development scientists currently develop food products making use of a variety of known ingredients such as dextrose, coco, peanut flour, etc.

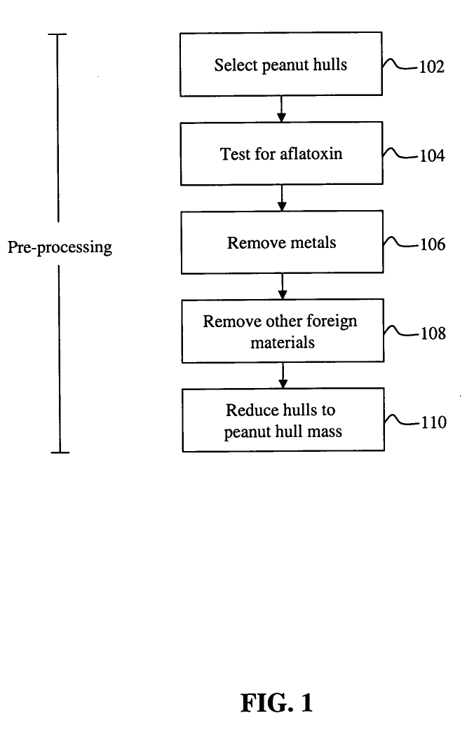

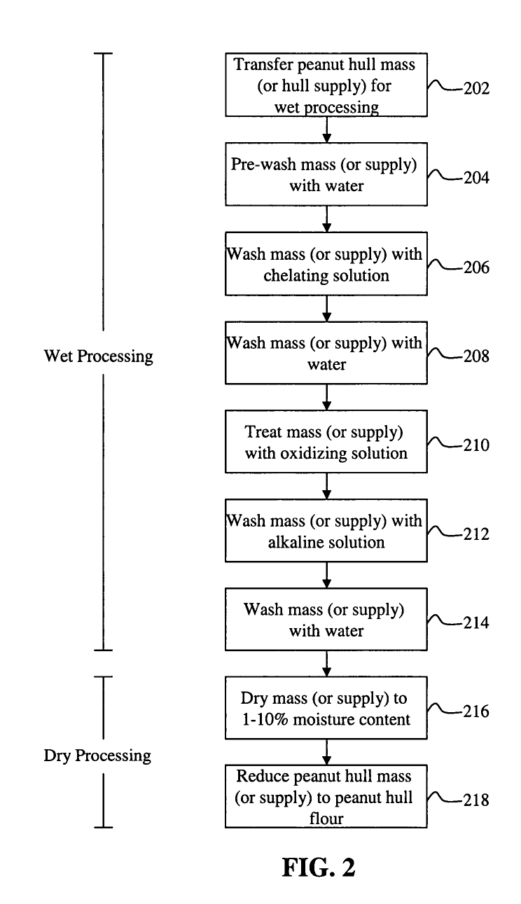

FIG. 1 illustrates an optional system and method for pre-processing a peanut hull supply into a peanut hull mass according to at least one exemplary embodiment of the present invention. Alternatively, a suitable peanut hull mass for use in the exemplary process of FIG. 2 (described below) can be provided by or procured from other sources as will be appreciated by one having ordinary skill in the art. As another alternative, as will be appreciated by one having ordinary skill in the art, a peanut hull supply such as standard hull supply (e.g., from a peanut shelling plant) can be the starting material of the exemplary process of FIG. 2. In other words, a peanut hull supply that may have not been pre-processed can be the starting material of the exemplary process of FIG. 2 in accordance with at least one exemplary embodiment.

The starting peanut hull supply for the exemplary process of FIG. 1 can be the removed peanut hull pieces (e.g., byproducts) in the condition expected after peanuts are de-hulled by conventional shelling processes. Thus, the peanut hull material can be substantially whole peanut hull half-shells and broken fragments thereof. For example, suitable peanut hull material can be provided by or procured from peanut shellers who are primarily concerned with processing peanut kernels. For instance, a standard hull supply, as is known in the art, can be obtained from peanut shelling plants. Alternatively, whole peanut pods can be shelled and the kernel material and the peanut hull material can be separated where the peanut hull material is contemplated for use in accordance with at least one exemplary embodiment.

At step 102, no matter the source, the peanut hull supply can be selected for pre-processing. The peanut hulls may be selected based on any suitable criteria established or already in place such as whether the hulls are “top-grade”, or may be provided “as is”. At step 104, the peanut hulls can be tested for aflatoxin contamination by methods known to one having ordinary skill in the art.

If the peanut hulls are not excluded for processing due to aflatoxin contamination, the peanut hull material can be passed by one or magnets or, one or more metal detectors (or both) to remove metals at step 106 as is known to one having ordinary skill in the art. Although, both magnets and metal detectors can be used in conjunction, if one method is to be used singularly, it can be noted that metal detectors can better remove ferrous and non-ferrous materials, while magnets primarily remove ferrous materials. At step 108, the peanut hulls can be passed through a sizing machine to sieve out foreign materials such as non-metal materials as is known to one having ordinary skill in the art.

At step 110, the peanut hull supply can be reduced in particle size to that of a peanut hull mass via a mass grinder/mill system having one or more grinders/mills. For example, the grinder system can include a stainless steel Rig-Mill Model 2448 and the like known to one having ordinary skill in the art.

FIG. 2 illustrates a system and method for producing peanut hull flour from a peanut hull mass (e.g., milled peanut hulls) or a peanut hull supply (e.g., substantially not ground) having a wet processing portion and a dry processing portion. The peanut hull mass can be obtained from the exemplary process of FIG. 1, procured from a peanut hull processor and the like. A suitable peanut hull supply can be provided by or procured from peanut shellers who are primarily concerned with processing peanut kernels. For instance, a standard hull supply, as is known in the art, can be obtained from peanut shelling plants.

Notably, FIG. 2 illustrates a system and method that can be scalable meaning that it can be scaled-up and scaled-down depending on the quantities desired. Thus, the quantity of peanut hull flour desired can dictate the quantity of starting peanut hull mass (or supply) to be used and the quantity of peanut hull mass (or supply) provided can dictate the quantity of peanut hull flour produced. Also, as such, the equipment described can likewise be selected based on the scale at which production is desired.

For ease of reference without any intention to limit embodiments thereto, FIG. 2 is described below in reference to a peanut hull mass that may have been ground, for example, as described in conjunction with FIG. 1. Nevertheless, the use of a peanut hull supply that has not been substantially milled such as a standard hull supply is contemplated for use with the process of FIG. 2 as will be appreciated by one having ordinary skill in the art.

At step 202, a peanut hull mass can be transferred to a wet processing area. At step 204, the peanut hull mass can be pre-washed with water such as deionized water. The pre-wash can remove impurities such as soil and sand present in the peanut hull mass. To complete the wash, the liquid can be drained from the peanut hull mass. The peanut hull mass can be transferred to a vat/vessel such as an open agitated vat (e.g., stainless steel vat), a closed vat (e.g., stainless steel vat) or like vessels known to one having ordinary skill in the art.

Optionally, in at least one exemplary embodiment, the peanut hull mass can be washed with a chelating solution at step 206. Depending on the properties desired in the final peanut hull flour product, at least one exemplary embodiment for producing peanut hull flour may require that the peanut hull mass is washed with a chelating solution. The chelating solution can remove heavy metals such as lead, arsenic and cadmium. An exemplary chelating solution can contain a chelating agent such as ethylenediamine tetraacetic acid (“EDTA”) and deionized water. The concentration of EDTA can be 200 ppm to 400 ppm. The peanut hull mass can remain in the solution for up to two hours. To complete the wash, the liquid can be drained and extracted, for example, by decanter centrifuge technology (e.g., a stainless steel decanter centrifuge) or by hydraulic press technology (e.g., a stainless steel hydraulic press) and the like known to one having ordinary skill in the art.

If washed with a chelating solution, then the peanut hull mass can be thereafter washed with water such as deionized water at step 208. To complete the wash, the liquid can be drained and extracted for example, by centrifugation or by pressing and the like known to one having ordinary skill in the art. Whether being transferred from step 204 or step 208, the peanut hull mass can be transferred to another vat/vessel such as a closed agitated vat (e.g., stainless steel vat), an open agitated vat (e.g., stainless steel vat) or like vessels known to one having skill in the art. Alternatively, the peanut hull mass can remain in the same vessel.

At step 210, the peanut hull mass can be treated with an oxidizing solution for a period of time. An exemplary oxidizing solution can contain hydrogen peroxide as the oxidizing agent. Deionized water can be used in preparing the solution. Hydrogen peroxide concentration can be about 3% to 70% by weight/volume. In at least one exemplary embodiment, the hydrogen peroxide concentration can be between about 7.5% and 15% by mass. The peanut hull mass can be exposed to the hydrogen peroxide solution for a matter of minutes up to about twelve hours depending on the properties (or combination of properties) desired in the final peanut hull flour. For example, in at least one exemplary embodiment, the hydrogen peroxide concentration can be about 10% by mass and the treatment time can be four hours.

For example, the oxidizing treatment can bleach the peanut hull mass to a desired color. Moreover, in addition to bleaching, treating the peanut hull mass with an oxidizing solution can reduce (and even eliminate) bacteria, other microorganisms, toxins (e.g. aflatoxin), peanut allergens and the like to acceptable levels for human consumption. Thus, the treatment may both bleach and sterilize the peanut hull mass. Alternatively, singularly or in conjunction, the concentration of the oxidizing solution and the length of treatment can also be determined based on the textural qualities desired in the peanut hull flour as the texture (tactile quality) of the peanut hull mass and resulting flour can be varied due to the concentration of oxidizing agent and the length of treatment.

To complete the treatment, the liquid can be drained and extracted from the peanut hull mass by decanter centrifuge technology (e.g., a stainless steel decanter centrifuge) or hydraulic press technology (e.g., a stainless steel hydraulic press) and the like known to one having ordinary skill in the art.

Still referring to FIG. 2, at step 212, the peanut hull mass can be washed with an alkaline solution. The peanut hull mass may be washed in the same vessel or transferred to another vessel for washing. The alkaline solution can be a solution prepared from potassium hydroxide (KOH), sodium hydroxide (NaOH) and the like known to one having ordinary skill in the art. Also, the alkaline solution can be prepared using deionized water or distilled water and the like known to one having ordinary skill in the art. For instance, a KOH solution can have a concentration of about 0.00125 to 0.05% by weight/volume. To complete the wash, the liquid can be drained and extracted from the peanut hull mass. For example, while in a vat, the liquid can by drained and extracted from the peanut hull mass by centrifugation or by pressing and the like known to one having ordinary skill in the art.

At step 214, the peanut hull mass can be washed with water. Deionized water or distilled water can be used for washing at step 214. To complete the wash, the liquid can be drained and extracted. For example, the liquid can be drained and extracted by centrifugation or by pressing and the like known to one having ordinary skill in the art.

The peanut hull mass can then be transferred for dry processing, which may occur at a dry processing area. At step 216, the peanut hull mass can be dried by, for example, air and/or heat. The peanut hull mass can be dried to a moisture level (having a moisture content) ranging from 1% to 10% depending on the desired properties of the resulting peanut hull flour. The peanut hull mass can be dried using a dry air oven and like drying techniques known to one having ordinary skill in the art.

At step 218, the peanut hull mass can be reduced to peanut hull flour. For example, a flour grinder/mill system having one or more grinders can be used to grind the peanut hull mass into peanut hull flour. For example, the flour grinder system can have two to four grinders with at least two types of grinders being employed. In at least one exemplary embodiment, a stainless steel Alpine Pin Mill having three stainless steel Jet Pulverizer Mills in tandem can be used to reduce the peanut hull mass to peanut hull flour. The individual flour particles constituting the peanut hull flour can have diameter sizes ranging from less than 3 microns (micrometers) to about 300 microns.

Producing peanut hull flour including grind size of the peanut hull flour can be consistent with a variety of different specifications directed to various types of peanut hull flour as will be appreciated by one having ordinary skill in the art. Once produced, it can subsequently be package in a variety of different packaging sizes and configurations. For instance, peanut hull flour can be sized to a customer's specification and subsequently packaged for shipping.

Still referring to FIG. 2, the ratio of peanut hull flour as compared to the starting peanut hull mass by weight will vary depending on the qualities desired in the peanut hull flour ultimately produced. For example, determinations such as the grind size, color, texture, the steps use, the concentration of solutions, the time in each solution and the like can impact such a ratio. Also, the dissolution of product for any of a variety of reasons can impact such a ratio as will be appreciated by one having ordinary skill in the art. The peanut hull flour yield can be between about 67% and 88% of the peanut hull mass according to four laboratory tests (i.e. 67%, 78%, 85% and 88%) using different concentrations of the oxidizing solution and drying to different moisture contents.

Peanut hull flour produced according to at least one exemplary embodiment of the present invention can be suitable for human consumption in accordance with any U.S. laws and regulations that govern such standards. Laboratory tests have been conducted directed to certain properties for peanut hull flour produced according to at least one exemplary embodiment of the present invention.

Particularly, such peanut hull flour meets microbiological requirements, heavy metal requirements and aflatoxin requirements for a food-grade fiber additive. Exemplary peanut hull flour is found to be free of peanut allergens using the enzyme-linked immunosorbent assay (“ELISA”) method of analysis.

A typical analysis shows pesticide levels to be acceptable for a human food-grade product. There is no detectable organo halogen, organo nitrogen, organo phosphate and N-methyl carbamate.

A typical analysis also shows that the exemplary peanut hull flour has a total dietary fiber composition of between 71.4% and 72% where insoluble fiber is between 70.2% and 71.2% and soluble fiber is between 0.2% and 0.25%.

Total sugars as well as fructose, glucose, sucrose, maltose and lactose alone are analyzed using high-performance liquid chromatography (“HPLC”). A typical analysis shows that no sugars are detected (0.00%) in the exemplary peanut hull flour.

A typical analysis shows the protein content of the exemplary peanut hull flour to be 5.57% according to the Dumas method (f=5.46). The acid hydrolysis fat determination shows a fat content of 2.49%. The water activity is 0.329, which shows the exemplary peanut hull flour is substantially shelf-stable. A typical analysis also shows that Calories (FBDG subtracted) are 69 calories/100 g and Calories from fat are 22 calories/100 g.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of producing peanut hull flour comprising:
providing a peanut hull mass or a peanut hull supply;
treating the peanut hull mass or the peanut hull supply with an oxidizing solution;
washing the peanut hull mass or the peanut hull supply with an alkaline solution;
drying the peanut hull mass or the peanut hull supply; and
reducing the peanut hull mass or the peanut hull supply to a peanut hull flour.

2. The method of claim 1 further comprising:
washing the peanut hull mass or the peanut hull supply with a chelating solution.

3. The method of claim 2 wherein the chelating solution contains EDTA in a concentration between about 200 ppm and 400 ppm.

4. The method of claim 1 further comprising:
washing the peanut hull mass or the peanut hull supply with water one or more times.

5. The method of claim 1 wherein the oxidizing solution is a hydrogen peroxide solution.

6. The method of claim 5 wherein the hydrogen peroxide solution is between about 3% and 70% by weight/volume.

7. The method of claim 6 wherein the peanut hull mass is treated for one or more minutes up to about twelve hours.

8. The method of claim 5 wherein the hydrogen peroxide solution is between about 7.5% and 15% by mass.

9. The method of claim 1 wherein the alkaline solution is a potassium hydroxide solution between about 0.00125% and 0.05% by weight/volume.

10. The method of claim 1 wherein drying the peanut hull mass results in a moisture level between about 1% and 10%.

11. The method of claim 1 wherein the peanut hull flour comprises a plurality of peanut hull particles sized between about 3 microns and 300 microns in diameter.

12. A peanut hull flour produced according to the method of claim 1.

13. The peanut hull flour of claim 12 wherein the peanut hull flour comprises a plurality of peanut hull particles sized between about 3 microns and 300 microns in diameter.

14. The peanut hull flour of claim 12 wherein the peanut hull flour is acceptable for human consumption in accordance with U.S. laws and regulations.

15. The peanut hull flour of claim 12 wherein the peanut hull flour has a total dietary fiber content between about 71.4% and 72% by mass.

16. The peanut hull flour of claim 12 wherein the peanut hull flour is substantially free of peanut allergens.

17. A system for producing peanut hull flour comprising:
a wet processing portion having one or more agitated vats for exposing a peanut hull mass or a peanut hull supply to at least an oxidizing solution and an alkaline solution; and
a dry processing portion having a flour grinder system for reducing the peanut hull mass or a peanut hull supply into a peanut hull flour.

18. The system of claim 17 wherein the dry processing portion has an oven for drying the peanut hull mass or peanut hull supply.

19. The system of claim 17 further comprising:
a pre-processing portion having a mass grinder system for reducing the peanut hull supply into the peanut hull mass wherein the peanut hull mass is subjected to the wet processing portion and the dry processing portion to the exclusion of the peanut hull supply.

20. The system of claim 19 wherein the pre-processing portion has one or more magnets and at least one sizing machine.

21. The system of claim 17 wherein the oxidizing solution is a hydrogen peroxide solution.
